(19) United States
(12) Patent Application Publication
(10) Pub. No.: US 2016/0333919 A1
(43) Pub. Date: Nov. 17, 2016

(54) METHOD AND SYSTEM FOR INSTALLING KEYLOCK INSERT

(71) Applicant: Caterpillar Inc., Peoria, IL (US)

(72) Inventors: Jordan B. Sharp, Fargo, ND (US); Charles A. Lindberg, Fargo, ND (US)

(73) Assignee: Caterpillar Inc., Peoria, IL (US)

(21) Appl. No.: 15/219,062

(22) Filed: Jul. 25, 2016

(51) Int. Cl. F16B 39/10

(52) U.S. Cl. CPC F16B 39/10

(57) ABSTRACT

In one aspect of the present disclosure, a method for installing a keylock insert into a tapped hole of a structure is disclosed. The keylock insert having a first end, a second end, internal threads, external threads, and a plurality of pins extending away from the first surface along an axis of the keylock insert. The method comprises positioning the second end of the keylock insert parallel to a mounting surface of the structure and the avis of the keylock insert being oriented along an axis of the tapped hole. The method further comprises fastening the keylock insert into the tapped hole, such that threads of the tapped hole being mated with the external threads of the keylock insert, and securing the key lock insert within the tapped hole by a fastening system, the fastening system deforming and compressing the plurality pins of the keylock insert between the tapped hole and the external threads of the keylock insert.

### TECHNICAL FIELD

The present disclosure relates to key lock inserts, and more specifically to a method and system for installing the keylock insert efficiently within a remanufactured or repaired hole.

### BACKGROUND

Threaded holes (also called tapped holes) are designed for securing various components of a machine, such as a flywheel fastened to an engine crankshaft, by the use of threaded fasteners. During operations, the threaded holes may get damaged due to induced stresses and cyclic loads. The threaded holes may also be damaged due to harsh working conditions, such as rusting, or heat. As a result, the components tend to malfunction due to lack of support from the threaded fasteners, and hence cause the machine downtime. Therefore, there is a need for remanufacturing damaged holes to original specifications for reuse.

During remanufacturing, damaged threads of the damaged holes are repaired by reboring the damaged holes and using a keylock insert for reusing the damaged holes. Conventionally, the installation of the keylock insert requires special tools and skilled operators to property install the keylock insert within the tapped holes. Further, special procedures are followed for proper alignment of the keylock insert within the tapped hole.

Currently, during the installation of the keylock insert, a hammer is commonly used to make pins of the keylock insert flush within the tapped hole and lock into the threads of the tapped holes. However, hammering of the pins may damage the threads of both the tapped hole and the key lock insert. Moreover, hammering of the pins may also damage the pins and, in turn, make the keylock insert inefficient. Furthermore, hammering is cumbersome for the operator and there are chances of misalignment of the key lock insert with respect to a vertical axis of the tapped hole. As a result, the conventional techniques suffer from inefficiency, lack of reliability and involve additional rework.

Therefore, there is a need for a method and system for installing the keylock insert within the tapped hole.

### SUMMARY OF THE DISCLOSURE

In one aspect of the present disclosure, a method for installing a keylock insert into a tapped hole of a structure is disclosed. The keylock insert having a first end, a second end, internal threads, external threads, and a plurality of pins extending away from the first surface along an axis of the keylock insert. The method comprises positioning the second end of the keylock insert parallel to a mounting surface of the structure and the axis of the keylock insert being oriented along an axis of the tapped hole. The method further comprises fastening the key lock insert into the tapped hole, such that threads of the tapped hole being mated with the external threads of the keylock insert, and securing the keylock insert within the tapped hole by a fastening system, the fastening system deforming and compressing the plurality pins of the keylock insert between the tapped hole and the external threads of the keylock insert.

In another aspect of the present disclosure, a fastening system for installing a keylock insert into a tapped hole is disclosed. The system includes a bolt having a head portion and a cylindrical portion, the cylindrical portion having threads extending thereon, a thrust bearing having a first race and a second race, the thrust bearing having an inner surface and an outer surface, the inner surface having a hollow cavity for receiving the bolt, and at least one washer coupled to the thrust bearing via the second race. Then at least one washer is configured to apply a uniform thrust to compress a plurality of pins of the keylock insert into the tapped hole and protect the bearing from damage. Further locking the plurality of pins between threads of the lapped hole and external threads of the keylock insert in a manner that the keylock insert being permanently fixed in a way that an axis of the keylock insert overlaps with an axis of the lapped hole.

Other features and aspects of this disclosure will be apparent from the following description and the accompanying drawings.

### BRIEF DESCRIPTION OF THE DRAWINGS

FIG. 1 is a perspective view of a structure having at least one repaired hole to receive a keylock insert, in accordance with the concepts of the present disclosure;

FIG. 2 is a perspective view of a fastening system for securing the keylock insert in the repaired hole of FIG. 1, in accordance with the concepts of the present disclosure;

FIG. 3 is a perspective view depicting the fastening system for pushing pins of the keylock insert into the repaired hole of FIG. 1, in accordance with the concepts of the present disclosure;

FIG. 4 is a side sectional view along a section 3-3″, illustrating the keylock insert having protruded pins and the fastening system for pushing the protruded pins into the repaired holes, in accordance with the concepts of the present disclosure; and

FIG. 5 is a side sectional view along the section line 3-3″, illustrating the keylock insert with the pins being locked into the repaired hole using the fastening system, in accordance with the concepts of the present disclosure.

### DETAILED DESCRIPTION

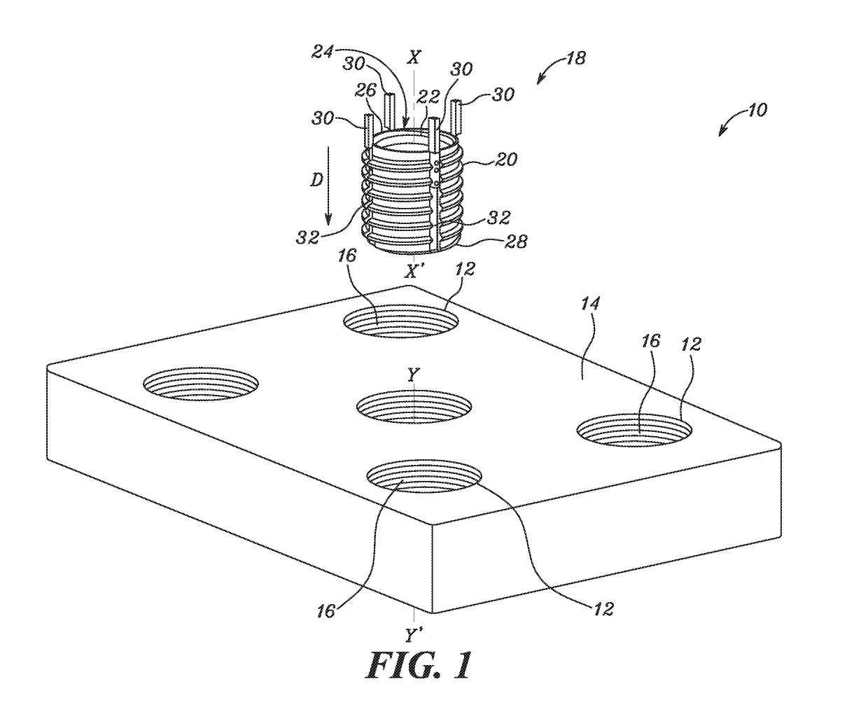

Referring to FIG. 1, an exemplary structure 10 being remanufactured is illustrated. Remanufacturing involves repair or replacement of damaged or obsolete structure to original specification for reuse. The structure 10 includes a number of tapped holes 12 (also known as repaired holes 12) spaced apart from each other and disposed over a mounting surface 14. In an example, the tapped holes 12 are utilized for mounting various parts of the machine, such as, but not limited to, an engine casing, a support bracket among others. The tapped holes 12 having threads 16 around its circumferential surface. It will be apparent to one skilled in the art that the dimension and count of the tapped holes 12, patterns of the threads 16 may differ without departing from the meaning and the scope of the disclosure.

The tapped holes 12 are provided to receive a keylock insert 18. The key lock insert 18 having external threads 20, internal threads 22, a first hollow cavity 24, a first end 26, a second end 28, a number of keys 30 (also called pins 30), a number of grooves 32 extending from the first end 26 till the second end 28. The keylock insert 18 is used to repair damaged or worn out threads by inserting the keylock insert 18 in the damaged thread. The grooves 32 are provided to receive the keys 30 in an axial direction ‘D’. Further, the keylock insert 18 may include chamfers (not shown) on the second end 28 to aid in fitment. During assembly, the external threads 20 of the keylock insert 18 are mated with the threads 16 of the tapped holes 12. As an example, the keylock insert 18 may be manually tightened inside the lapped hole 12 until the first end 26 is parallel and coplanar with the mounting surface 14 of the component 10. During fastening of the keylock insert 18, the keylock insert 18 is positioned within the tapped holes 12 in a manner that the second end 28 of the keylock insert 18 is parallel to the mounting surface 14 of the structure 10 and the axis X-X′ of the keylock insert 18 being oriented along axis Y-Y′ of the tapped holes 12.

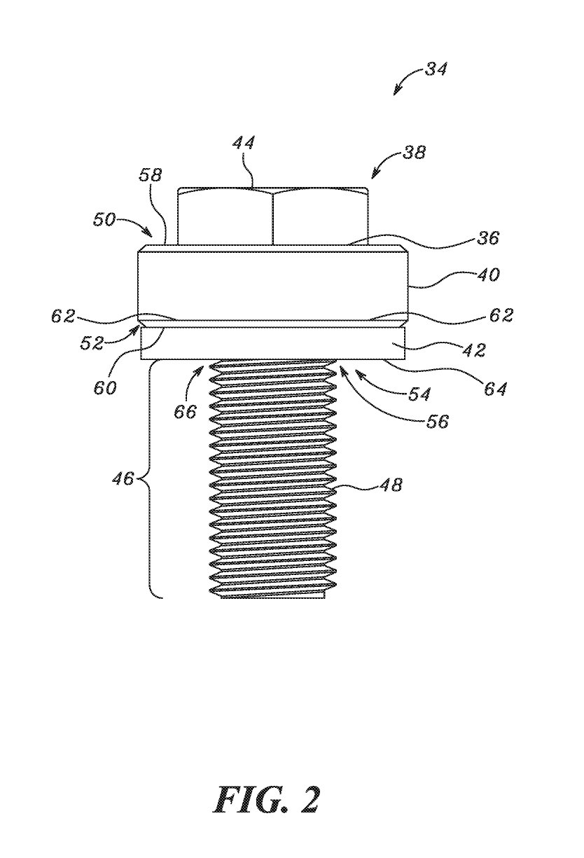

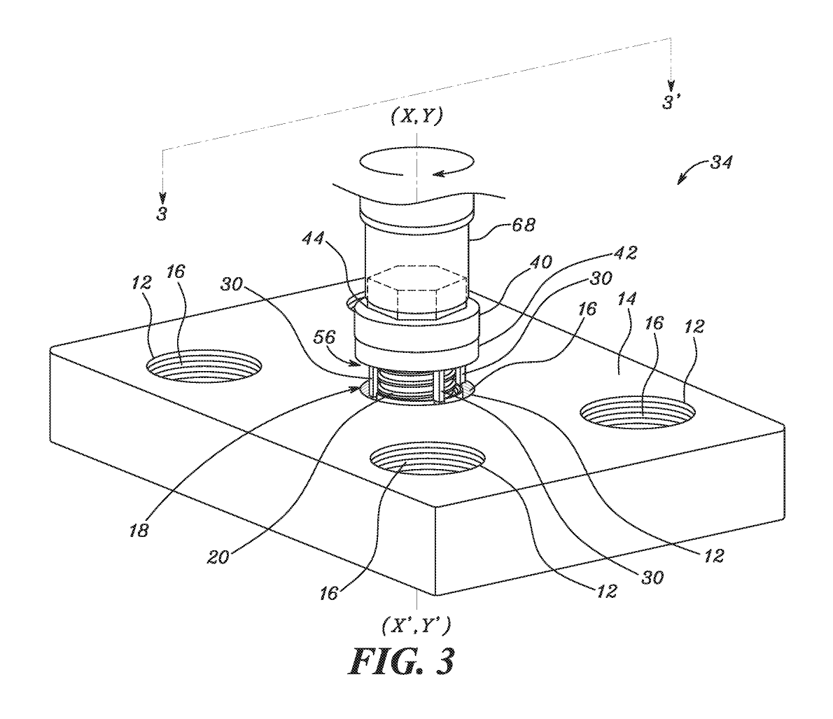

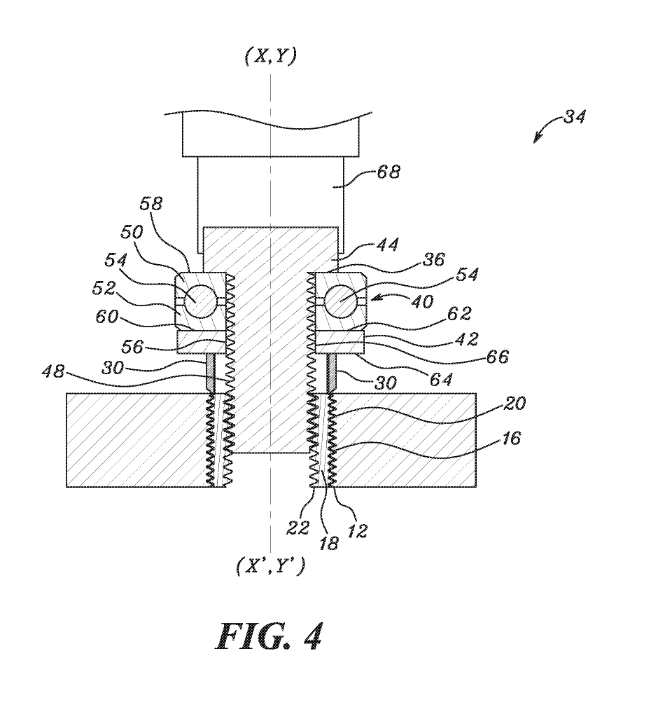

Referring to FIG. 2 and 3, a fastening system 34 is utilized to permanently install the keylock insert 18 within the tapped holes 12. The fastening system 34 includes a bolt 38 having a first surface 36 provided to apply a force to tighten the key lock insert 18. The fastening system 34 further includes a thrust bearing 40 and a washer 42. The bolt 38 includes a head portion 44 and a cylindrical portion 46 having threads 48. The cylindrical portion 46 is provided to be received into the keylock insert 18. Further, the thrust bearing 40 having a first race 50, a second race 52 and a number of bearing balls 54 (refer to FIG. 4) therebetween. The thrust bearing 40 further having a second hollow cavity 56 (refer to FIG. 4), a second surface 58 and a third surface 60. The second hollow cavity 56 is provided to receive the cylindrical portion 46 of the bolt 38.

The washer 42 includes a fourth surface 62, a fifth surface 64, and a third hollow cavity 66 (also refer to FIG. 4). The third hollow cavity 66 is provided to receive the cylindrical portion 46 of the bolt 38. During assembly procedure, the washer 42 allows uniform axial push on the pins 30. It will be apparent to one skilled in the art that there may be more than one washer 42 with varying configuration attached to the thrust bearing 40 for facilitating uniform compression on the pins 30 without departing from the meaning and the scope of the disclosure. The fastening system 34 may be driven with the help of a tool 68 (see in FIG. 4). Further, the tool 68 is utilized to provide tightening torque to the bolt 38 (as shown by axis of rotation in a clockwise direction). It will be apparent to the person skilled in the art that the fastening system 34 may be altered in the design, shapes and configuration without departing from the scope and the meaning of the disclosure. Also the tool 68 may be a hand wrench or machine driven Further the tool 68 is interlocked with the head portion 44 of the bolt 38 for tightening the keylock insert 18 in the tapped hole 12. It will be apparent to the person skilled in the art that the bolt 38 may be of a different configuration with varying head shape, thread patterns or materials without departing from the scope and the meaning of the disclosure.

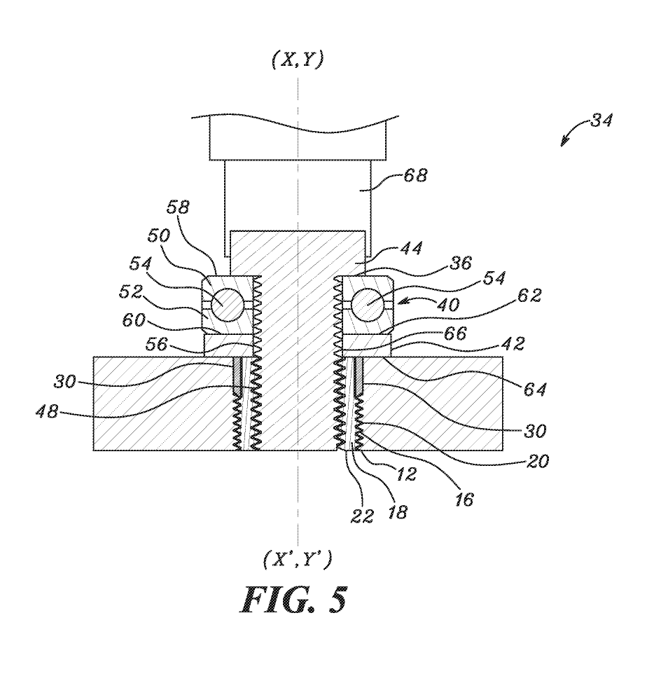

Referring to FIG. 4 and 5, the fastening system 34 is being driven by the tool 68 for pushing the keys 30 into the tapped holes 12. The lightening of the bolt 38 causes the threads 48 of the bolt 38 to be temporarily tightened into the internal threads 22 of the keylock insert 18. The procedure of tightening causes the first surface 36 of the head portion 44 to come in contact with second surface 58 of the thrust bearing 40. Further, the third surface 60 comes in contact with the fourth surface 62, and thereby the washer 42 begins to uniformly drive down the keys 30. The washer 42 applies a uniform thrust to compress the pins 30 of the key lock insert 18 into the tapped hole 12 and further locking the plurality of pins 30 in a manner that the key lock insert 18 being permanently fixed in a way that the axis X-X′ of the keylock insert 18 overlaps with the axis Y-Y′ of the tapped hole 12. As a result, the fastening system 34 compresses and deforms the pins 30 of the keylock insert 18 between the tapped hole 12 and the external threads 20 of the keylock insert 18. The keylock insert 18 may be made of materials, such as, but not limited to steel, aluminum, among others. Also the shape, configuration and the number of pins 30 of the keylock insert 18 may vary without departing from the meaning and the scope of the disclosure.

### INDUSTRIAL APPLICABILITY

Currently, hammering is a challenge for a machinist for inserting the keys 30 of the keylock insert 18. Uniform and gradual insertion of the keys 30 using the fastening system 34 reduces the risk of damage to the keys 30, the threads 16 and the external threads 20 of the keylock insert 18.

The washer 42 assisted by the thrust bearing 40 provides a uniform axial load on the keys 30, and hence mitigates the risks of damage to the threads 16 and the external threads 20. The machinist may hand screw the keylock insert 18 into the tapped holes 12 and tighten the keylock insert 18 in a single go in order to save assembly time and without requiring any specially trained personnel. The fastening system 34 may be easily manufactured with a low cost.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for installing a keylock insert into a tapped hole of a structure, the keylock insert having a first end, a second end, internal threads, external threads, and a plurality of pins extending away from the first end along an axis of the keylock insert, the method comprising:
positioning the second end of the keylock insert parallel to a mounting surface of the structure and the axis of the keylock insert being oriented along an axis of the tapped hole;
fastening the keylock insert into the tapped hole, such that threads of the tapped hole being mated with the external threads of the keylock insert: and
securing the keylock insert within the tapped hole by a fastening system, the fastening system deforming and compressing the plurality pins of the keylock insert between the tapped hole and the external threads of the keylock insert.

2. A fastening system for installing a keylock insert into a tapped hole, the fastening system comprising:
a bolt having a head portion and a cylindrical portion, the cylindrical portion having threads extending thereon;
a thrust bearing having a first race and a second race, the thrust bearing having an inner surface and an outer surface, the inner surface having a hollow cavity for receiving the bolt; and
at least one washer coupled to the thrust bearing via the second race;
wherein the at least one washer is configured to apply a uniform thrust to compress a plurality of pins of the keylock insert into the tapped hole and further locking the plurality of pins between threads of the tapped hole and external threads of the keylock insert in a manner that the keylock insert being permanently fixed in a way that an axis of the keylock insert overlaps with an axis of the tapped hole.
